(19) United States
(12) Patent Application Publication
(10) Pub. No.: US 2011/0306244 A1
(43) Pub. Date: Dec. 15, 2011

(54) CABLE CONNECTOR ASSEMBLY HAVING AN ADAPTER PLATE FOR GROUNDING

(75) Inventors: XUE-LIANG ZHANG, Kunshan (CN); QING-MAN ZHU, Kunshan (CN); CHIEN-CHIUNG WANG, New Taipei (TW)

(73) Assignee: HON HAI PRECISION INDUSTRY CO., LTD., New Taipei (TW)

(21) Appl. No.: 13/155,481

(22) Filed: Jun. 8, 2011

(30) Foreign Application Priority Data
Jun. 9, 2010 (TW) 99118664

(51) Int. Cl. H01R 9/03

(52) U.S. Cl. 439/624

(57) ABSTRACT

A cable connector assembly (1) includes a cable (200), a connector (100) including a conductor subassembly (11), and an adapter plate (300). The cable includes a number of wires including a row of first wires (23) and a row of second wires (25). The conductor subassembly (11) has a number of first conductors (1123) and at least one second conductor (1122). The first wires are connected to the first conductors. The adapter plate is disposed between the row of first wires and the row of second wires and includes a conductive layer electrically connecting the second wires to the at least one second conductor.

### BACKGROUND OF THE INVENTION

1. Field of the Invention

The present invention relates to a cable connector assembly, and more particularly to a cable connector assembly suitable for use in dense cable wires configuration.

2. Description of Related Art

U.S. Pat. No. 6,685,501 B1 issued to Wu et al. on Feb. 3, 2004 discloses a cable connector comprising a pair of complementary shells, a PCB (printed circuit board) received in the shells, and a cable electrically connected to the PCB. The cable includes a plurality of wires. Each of the wires includes a signal pair and a grounding conductor. The signal pair includes a first signal conductor and a second signal conductor soldered to the top and bottom of the PCB respectively. The cable connector further includes a plurality of shielding plates soldered to the PCB. The grounding conductors are soldered to shielding plates, respectively, which is costly and inconvenient.

Hence, a cable connector assembly having an adapter plate is desired.

### BRIEF SUMMARY OF THE INVENTION

The present invention provides a cable connector assembly comprising a cable, a connector including a conductor subassembly, and an adapter plate. The cable includes a plurality of wires including a row of first wires and a row of second wires. The conductor subassembly has a plurality of first conductors and at least one second conductor. The first wires are connected to the first conductors. The adapter plate is disposed between the row of first wires and the row of second wires and includes a conductive layer electrically connecting the second wires to the at least one second conductor.

The second wires are soldered to the adapter plate so as to provide more room for the first wires. Soldering of the second wires to the adapter plate is also easy.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a cable connector assembly in accordance with the present invention;

FIG. 2 is a perspective view of the cable connector assembly shown in FIG. 1, with a top shell being removed;

FIG. 3 is a partially exploded view of the cable connector assembly as shown in FIG. 1;

FIG. 4 is an exploded view of the cable connector assembly of FIG. 3;

FIG. 5 is a perspective view of an adapter plate as shown in FIG. 4; and

FIG. 6 is an enlarged view of the circled portion in FIG. 3.

### DETAILED DESCRIPTION OF THE PREFERRED EMBODIMENT

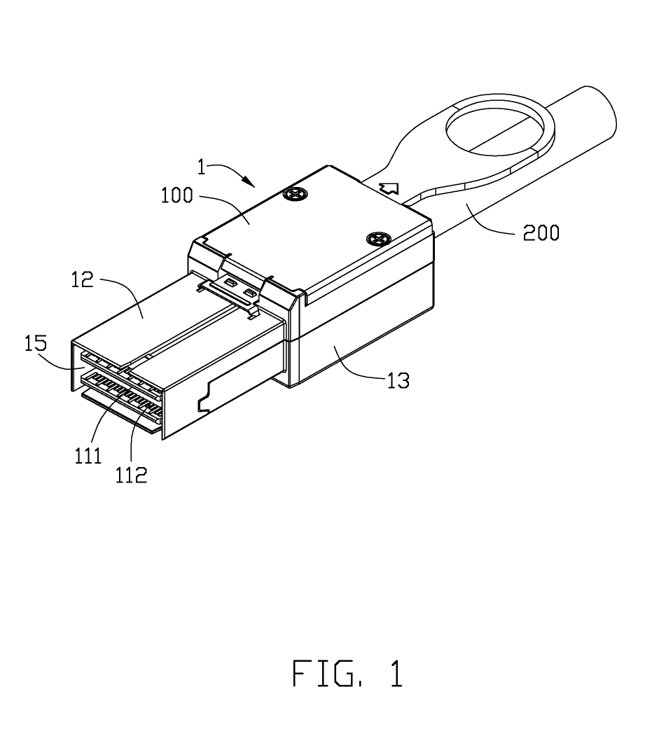

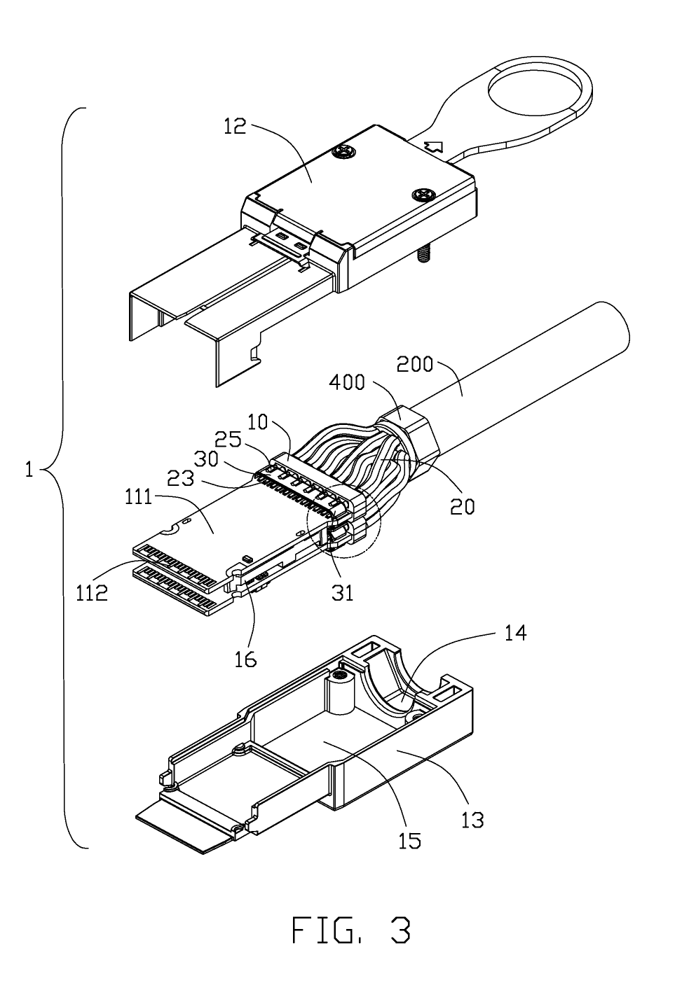

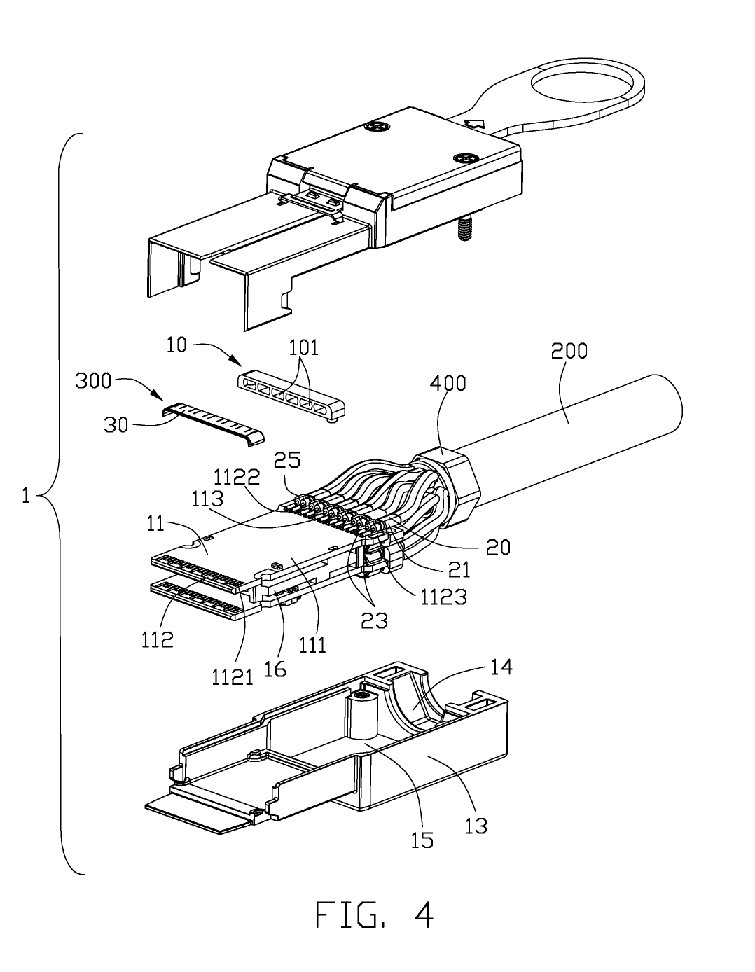

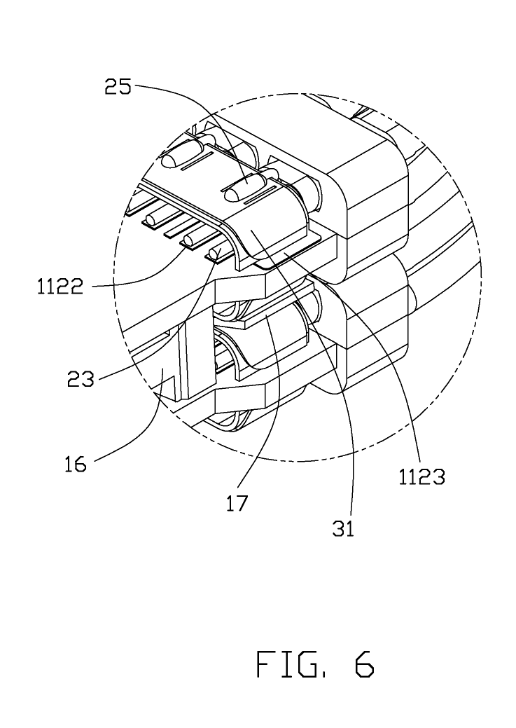

Reference will now be made to the drawing figures to describe the preferred embodiment of the present invention in detail. Referring to FIGS. 1-6, the present invention provides a cable connector assembly 1 including a connector 100, a cable 200 electrically connected to the connector 100, an adapter plate 300, and a conductive ring 400 assembled between the connector 100 and the cable 200.

The connector 100 includes a shell, a conductor subassembly 11 received in the shell, and a spacer 10 on the conductor subassembly 11 adjacent to the adapter plate 300. The shell includes a top shell 12 and a bottom shell 13 cooperating with each other to define a holding slot 14 for holding the cable 200 and a receiving room 15 for receiving the conductor subassembly 11 and the cable 200.

The conductor subassembly 11 comprises a pair of horizontal PCBs (printed circuit boards) 111. Each of the PCBs 111 connects with two adapter plates 300 at opposite sides. Each of the PCBs 111 is provided with two conductive regions 112, 113 at front side and rear side, respectively. The conductive region 113 is provided with a pair of second conductors 1123 and a plurality of first conductors 1122 located between the pair of second conductors 1123. The first conductors 1122 constitute signal pads 1122 provided on the PCB 111 and the pair of second conductors 1123 constitute grounding pads 1123 provided on the PCB 111. The conductive region 112 is provided with a plurality of fingers 1121 for engaging with a complementary connector (not shown). Each of the PCBs 111 further has a plurality of conductive circuit traces (not shown) connecting the fingers 1121 to the signal and grounding pads 1122, 1123.

The connector 100 further includes an insulative body 16 sandwiched between the pair of PCBs 111 and a shield plate 17 held by the insulative body 16. The shield plate 17 is used for reducing the crosstalk between the pair of PCBs 111. The shield plate 17 is retained in the insulative body 16 through insert molding.

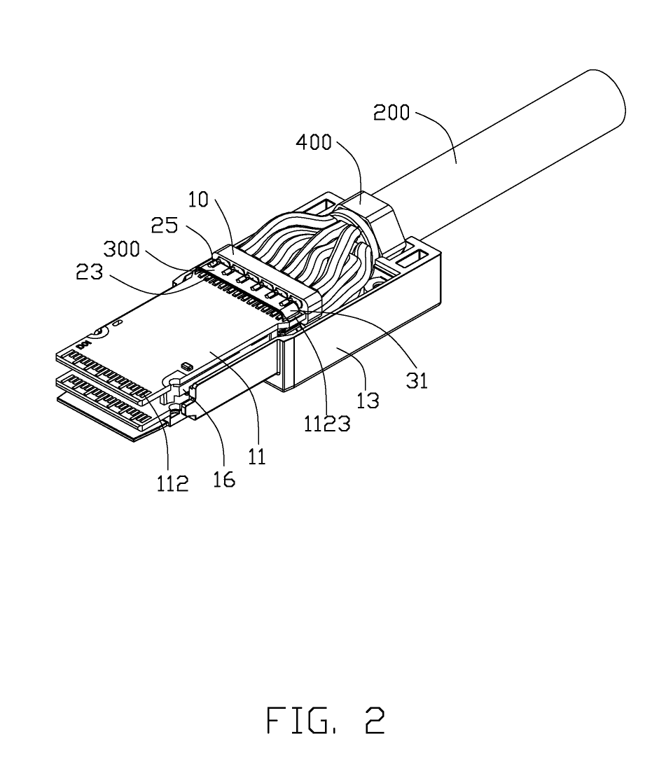

Referring to FIGS. 2-4, the spacer 10 defines a plurality of mounting holes 101 in one row.

The cable 200 includes a plurality of wires 20 including a row of first wires or signal wires 23 and a row of second wires or grounding wires 25. Each one of the wires 20 comprises two signal wires 23 and one grounding wire 25. The signal wires 23 are disposed in a first row, and the grounding wires 25 are disposed in a second row. The adapter plate 300 is disposed between the first row of signal wires 23 and the second row of grounding wires 25. The cable 200 further includes a plurality of shielding layers 21 enclosing the wires 20.

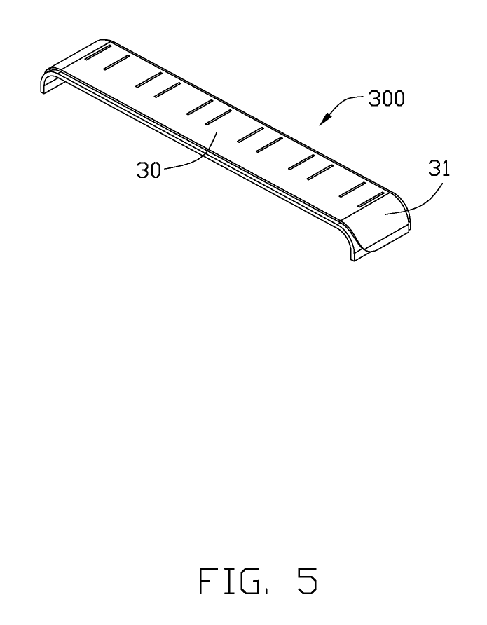

Referring to FIG. 5, the adapter plate 300 comprises a plate shaped horizontal portion 30 parallel with the PCB 111 and two end portions 31 substaintically perpendicular to the horizontal portion 30. The adapter plate 300 may suitably be a Flexible Printed Circuit (FPC) board. The FPC 300 is formed of an insulative substrate and a grounding layer.

In assembling the cable connector assembly 1, the wires 20 of the cable 200 are firstly inserted through the mounting holes 101 respectively. Then, the row of signal wires 23 are soldered to the signal pads 1122 of the PCB 111. The adapter plate 300 is disposed between signal wires 23 and grounding wires 25. Then, the grounding wires 25 are soldered to the grounding layer on the one hand and the grounding pads 1123 are soldered to distal ends of the grounding layer on the other hand. Therefore, the grounding wires 25 electrically connect the grounding pads 1123 through grounding layer of the adapter plate 300. Finally, the PCB 111, the spacer 10, the adapter plates 300 and the cable 200 are assembled into the receiving room 15. The conductive ring 400 holds the wires 20 and is received in the holding slot 14. While the preferred embodiment shows a stacked arrangement including two PCBs 111, it is apparent that the present invention is not so limited. Nor is the present invention limited to a respective adapter plate or spacer on either side of each PCB.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A cable connector assembly comprising:
a cable including a plurality of wires including a row of first wires and a row of second wires;
a connector comprising a conductor subassembly having a plurality of first conductors and at least one second conductor, the first conductors being connected to the first wires; and
an adapter plate disposed between the row of first wires and the row of second wires, the adapter plate comprising a conductive layer electrically connecting the second wires to the at least one second conductor.

2. The cable connector assembly as claimed in claim 1, wherein the conductor subassembly comprises a printed circuit board (PCB), the first conductors constitute signal pads provided on the PCB, and there are provided two second conductors constituting two grounding pads provided on the PCB; and the first wires constitute signal wires, and the second wires constitute grounding wires.

3. The cable connector assembly as claimed in claim 2, wherein the signal pads are located between the two grounding pads.

4. The cable connector assembly as claimed in claim 2, wherein said connector comprises a spacer adjacent to the adapter plate, the spacer defining a row of mounting holes, the wires being inserted through the mounting holes.

5. The cable connector assembly as claimed in claim 4, wherein each of the mounting holes receives one of said grounding wires and two of said signal wires.

6. The cable connector assembly as claimed in claim 2, wherein the adapter plate comprises a horizontal portion parallel with the PCB and two end portions substantially perpendicular to the horizontal portion.

7. The cable connector assembly as claimed in claim 1, wherein the adapter plate comprises a flexible printed circuit board formed of an insulative substrate and the conductive layer, and the conductive layer constitutes a grounding layer.

8. The cable connector assembly as claimed in claim 1, wherein said connector comprises a first and a second shells defining a receiving room, the conductor subassembly and the adapter plate being received in the receiving room.

9. The cable connector assembly as claimed in claim 1, wherein the conductor subassembly comprises two PCBs, two adapter plates are provided at opposite sides of each PCB, and each adapter plate is disposed between associated row of first and second wires.

10. A cable connector assembly comprising:
a housing defining a receiving cavity;
at least one printed circuit board disposed in the receiving cavity with a front edge to form a front mating port and a rear edge to form a rear mounting port;
a plurality of wire sets each defining a pair of signal wires associated with a grounding wire, the signal wires being electrically and mechanically connected to the rear mounting port; and
a grounding device mounted to the rear mounting port and including an insulative substrate facing toward the printed circuit board with the signal wires therebetween, and a grounding layer facing away from the printed circuit board; wherein
the grounding wires are connected to the grounding layer.

11. The cable connector assembly as claimed in claim 10, wherein the grounding device is electrically and mechanically connected to the rear mounting port.

12. The cable connector assembly as claimed in claim 10, further including a spacer to regulate the wire sets.

13. The cable connector assembly as claimed in claim 10, wherein there are two of said printed circuit boards commonly sandwiching an insulative body, and each of said printed circuit board is connected to the corresponding wire sets.

14. The cable connector assembly as claimed in claim 10, wherein the wire sets are assembled to two opposite surfaces of the printed circuit board.

15. The cable connector assembly as claimed in claim 15, further including two spacers stacked with each other to respectively regulate the corresponding wire sets assembled unto the two opposite surfaces of the printed circuit board.

16. The cable connector assembly as claimed in claim 10, wherein the grounding device extends in a transverse direction perpendicular to a front-to-back direction, and is spaced from the signal wires in a vertical direction perpendicular to both said transverse direction and said front-to-back direction.

17. A cable connector assembly comprising:
a housing defining a receiving cavity;
a pair of printed circuit boards sandwiching an insulative body to commonly be received I the receiving cavity, each of said printed circuit board defining a front mating port and a rear mounting port;
two sets of wires respectively mechanically and electrically connected to two opposite surfaces of each of said printed circuit boards;
each set of the wires including a plurality of differential pairs each being a pair of signal wires equipped with a grounding wire; wherein
the signal wires are directly mechanically and electrically connected to the rear mounting port while the grounding wire is mechanically and electrically connected to an adaptor plate which is directly mechanically and electrically connected to the rear mounting port under condition of being spaced from the corresponding signal wires in a vertical direction perpendicular to the printed circuit board.

18. The electrical connector assembly as claimed in claim 17, wherein the adaptor plate extends in a transverse direction perpendicular to both the vertical direction and a front-to-back direction.

19. The electrical connector assembly as claimed in claim 17, wherein there are four adaptors respectively mounted to the two opposite surfaces of the two printed circuit boards.

20. The electrical connector assembly as claimed in claim 19, further including two spacers stacked together to regulate two sets of wires linked to each of the printed circuit boards.
